(19) United States
(12) Patent Application Publication
(10) Pub. No.: US 2018/0093467 A1
(43) Pub. Date: Apr. 5, 2018

(54) GRAVURE CYLINDER AND MANUFACTURING METHOD THEREOF

(71) Applicant: THINK LABORATORY CO., LTD., Chiba (JP)

(72) Inventors: Shintaro SUGAWARA, Chiba (JP); Yoshinobu SATO, Chiba (JP)

(73) Assignee: THINK LABORATORY CO., LTD., Chiba (JP)

(21) Appl. No.: 15/559,262

(22) PCT Filed: Mar. 29, 2016
(86) PCT No.: PCT/JP2016/060135

§ 371 Date: Sep. 18, 2017

(30) Foreign Application Priority Data
Apr. 14, 2015 (JP) 2015-082271

(51) Int. Cl. B41F 13/11; B41C 1/18; B41F 9/00; B41N 1/06; B41N 1/20

(52) U.S. Cl. CPC B41F 13/11; B41C 1/18; B41M 3/14; B41N 1/06; B41N 1/20; B41F 9/00

(57) ABSTRACT

Provided are a gravure cylinder, which has satisfactory wear resistance as the gravure cylinder and includes a surface reinforcing coating layer having wear resistance equal to or more than that of chromium plating using hexavalent chromium, a method of manufacturing the gravure cylinder, and a method of manufacturing a printed matter using the gravure cylinder. The gravure cylinder includes: a plate base material; a recess layer, which is formed on a surface of the plate base material and includes a large number of recesses formed on the surface; and a surface reinforcing coating layer configured to cover the recess layer with chromium nitride or carbon nitride, in which the surface reinforcing coating layer is formed by reactive sputtering.

### TECHNICAL FIELD

The present invention relates to a gravure cylinder and a method of manufacturing the gravure cylinder, and a method of manufacturing a printed matter using the gravure cylinder.

### BACKGROUND ART

In gravure printing, minute recesses (gravure cells) in accordance with plate making information are formed on a plate base material to manufacture a plate surface, and ink is filled into the gravure cells and transferred onto a material to be printed. In a general related-art gravure cylinder (plate-making roll for gravure printing), plate making is completed through the following process: a copper-plated layer for forming a plate surface is formed on a surface of a plate base material that is a hollow roll made of a metal, for example, aluminum and iron, or on a surface of a plate base material that is a hollow roll made of plastic, for example, carbon fiber reinforced plastic (CFRP); a photoresist is applied onto the copper-plated layer; the photoresist is subjected to light exposure and development to form a resist pattern; a large number of minute recesses (gravure cells) are formed in accordance with plate making information by an etching method or an electronic engraving method; and then a hard chromium layer is formed by chromium plating for increasing plate life of the gravure cylinder to provide a surface reinforcing coating layer.

However, in the chromium plating step, toxic hexavalent chromium is used, and hence extra cost is required for maintaining safety of an operation. Further, when liquid waste disposal of plated chromium is not performed, there is a problem of occurrence of pollution. Thus, there is a demand for the advent of a surface reinforcing coating layer that replaces the chromium layer.

For example, in Patent Document 1, there is a disclosure of a method of manufacturing a gravure printing roll, which involves subjecting a surface of a gravure printing roll to electrolytic copper plating, forming unevenness corresponding to an original drawing for printing on the resultant surface of the gravure printing roll, and then forming a coating film made of chromium or a chromium compound on the resultant by vacuum deposition.

However, when an attempt is made to form chromium, chromium nitride, or chromium carbide into a film on the plated copper by vacuum deposition or ion plating as disclosed in Patent Document 1, the temperature of the gravure printing roll increases to about 400° C., resulting in strain of the plated copper.

### PRIOR ART DOCUMENT

### Patent Document

### Patent Document 1: JP Hei 06-39994 A

### SUMMARY OF THE INVENTION

### Problems to be Solved by the Invention

The present invention has been made in view of the above-mentioned problems of the related art, and an object of the present invention is to provide a gravure cylinder which has satisfactory wear resistance as the gravure cylinder and includes a surface reinforcing coating layer having wear resistance equal to or more than that of chromium plating using hexavalent chromium, a method of manufacturing the gravure cylinder, and a method of manufacturing a printed matter using the gravure cylinder.

### Means for Solving Problems

In order to achieve the above-mentioned object, a gravure cylinder according to the present invention comprises: a plate base material; a recess layer, which is formed on a surface of the plate base material and includes a large number of recesses formed on the surface; and a surface reinforcing coating layer configured to cover the recess layer with chromium nitride or carbon nitride, in which the surface reinforcing coating layer is formed by reactive sputtering.

It is preferred that the gravure cylinder further comprises an intermediate layer formed between the recess layer and the surface reinforcing coating layer.

It is preferred that the intermediate layer comprises a metal intermediate layer. It is suitable that the intermediate layer is made of at least one kind of material selected from the group consisting of Ni, stainless steel, brass, Fe, Cr, Zn, Sn, Ti, Cu, and Al. The intermediate layer is made of at least one kind of material, and hence it goes without saying that the intermediate layer may be made of an alloy.

It is preferred that the metal intermediate layer comprises a chromium layer formed by sputtering or plating.

It is preferred that the gravure cylinder further comprises a binder layer formed between the recess layer and the intermediate layer.

It is preferred that the binder layer comprises a metal binder layer. It is suitable that the binder layer is made of at least one kind of material selected from the group consisting of Ni, stainless steel, brass, Fe, Cr, Zn, Sn, Ti, Cu, and Al. The binder layer is made of at least one kind of material, and hence it goes without saying that the binder layer may be made of an alloy.

It is preferred that the metal binder layer comprises a nickel layer formed by sputtering or plating.

A method of manufacturing a gravure cylinder according to the present invention comprises steps of; preparing a plate base material; forming a recess layer including a large number of recesses on a surface of the plate base material; and forming a surface reinforcing coating layer configured to cover the recess layer with chromium nitride or carbon nitride by reactive sputtering.

It is preferred that the method further comprises forming an intermediate layer between the recess layer and the surface reinforcing coating layer.

It is preferred that the intermediate layer comprises a metal intermediate layer. It is suitable that the intermediate layer is made of at least one kind of material selected from the group consisting of Ni, stainless steel, brass, Fe, Cr, Zn, Sn, Ti, Cu, and Al. The intermediate layer is made of at least one kind of material, and hence it goes without saying that the intermediate layer may be made of an alloy.

It is preferred that the metal intermediate layer comprises a chromium layer formed by sputtering or plating.

It is preferred that the method further comprises forming a binder layer between the recess layer and the intermediate layer.

It is preferred that the binder layer comprises a metal binder layer. It is suitable that the binder layer is made of at least one kind of material selected from the group consisting of Ni, stainless steel, brass, Fe, Cr, Zn, Sn, Ti, Cu, and Al. The binder layer is made of at least one kind of material, and hence it goes without saying that the binder layer may be made of an alloy.

It is preferred that the metal binder layer comprises a nickel layer formed by sputtering or plating.

A method of manufacturing a printed matter according to the present invention comprises a step of performing printing on a material to be printed through use of the gravure cylinder. A printed matter according to the present invention is printed by the said method of manufacturing a printed matter.

There is no particular limitation on the thickness of the surface reinforcing coating layer. However, from the viewpoint of manufacturing efficiency, the thickness is preferably from 1 μm to 10 μm, more preferably from 3 μm to 6 μm, still more preferably from 3 μm to 4 μm.

It is suitable that the plate base material is made of at least one kind of material selected from the group consisting of nickel, tungsten, chromium, titanium, gold, silver, platinum, stainless steel, iron, copper, and aluminum. The plate base material is made of at least one kind of material, and hence it goes without saying that the plate base material may be made of an alloy. Further, as the plate base material, carbon fiber reinforced plastic (CFRP) may also be applicable.

It is preferred that the plate base material comprises a cushion layer made of a rubber or a resin having a cushion property. Specifically, the plate base material may be a plate base material including a cushion layer in which a metal base material is formed on the cushion layer made of a rubber or a resin having a cushion property. As the cushion layer, a synthetic rubber, for example, silicon rubber, or a synthetic resin having elasticity, for example, polyurethane or polystyrene may be used. There is no particular limitation on the thickness of the cushion layer as long as the thickness is capable of imparting a cushion property, that is, elasticity. It is sufficient that the thickness is, for example, from about 1 cm to about 5 cm.

### Advantageous Effects of the Invention

The present invention has a remarkable effect of being capable of providing the gravure cylinder which has satisfactory wear resistance as the gravure cylinder and includes a surface reinforcing coating layer having wear resistance equal to or more than that of chromium plating using hexavalent chromium, the method of manufacturing the gravure cylinder, and the method of manufacturing a printed matter using the gravure cylinder.

### BRIEF DESCRIPTION OF DRAWINGS

FIG. 1 is an explanatory view for schematically illustrating manufacturing processes of one embodiment of a gravure cylinder according to the present invention. FIG. 1(a) is an entire sectional view of a plate base material. FIG. 1(b) is a partially enlarged sectional view for illustrating a state in which a copper-plated layer is formed on a surface of the plate base material. FIG. 1(c) is a partially enlarged sectional view for illustrating a state in which recesses are formed on the copper-plated layer of the plate base material to provide a recess layer. FIG. 1(d) is a partially enlarged sectional view for illustrating a state in which the recess layer is covered with a surface reinforcing coating layer.

FIG. 2 is a flowchart for illustrating a process sequence of a method of manufacturing the gravure cylinder illustrated in FIG. 1.

FIG. 3 is an explanatory view for schematically illustrating manufacturing processes of another embodiment of a gravure cylinder according to the present invention. FIG. 3(a) is an entire sectional view of a plate base material. FIG. 3(b) is a partially enlarged sectional view for illustrating a state in which a copper-plated layer is formed on a surface of the plate base material. FIG. 3(c) is a partially enlarged sectional view for illustrating a state in which recesses are formed on the copper-plated layer of the plate base material to provide a recess layer. FIG. 3(d) is a partially enlarged sectional view for illustrating a state in which an intermediate layer is formed on the recess layer. FIG. 3(e) is a partially enlarged sectional view for illustrating a state in which the intermediate layer is further covered with a surface reinforcing coating layer.

FIG. 4 is a flowchart for illustrating a process sequence of a method of manufacturing the gravure cylinder illustrated in FIG. 3.

FIG. 5 is an explanatory view for schematically illustrating manufacturing processes of still another embodiment of a gravure cylinder according to the present invention. FIG. 5(a) is an entire sectional view of a plate base material. FIG. 5(b) is a partially enlarged sectional view for illustrating a state in which a copper-plated layer is formed on a surface of the plate base material. FIG. 5(c) is a partially enlarged sectional view for illustrating a state in which recesses are formed on the copper-plated layer of the plate base material to provide a recess layer. FIG. 5(d) is a partially enlarged sectional view for illustrating a state in which a binder layer is formed on the recess layer. FIG. 5(e) is a partially enlarged sectional view for illustrating a state in which an intermediate layer is formed on the binder layer. FIG. 5(f) is a partially enlarged sectional view for illustrating a state in which the intermediate layer is further covered with a surface reinforcing coating layer.

FIG. 6 is a flowchart for illustrating a process sequence of a method of manufacturing the gravure cylinder illustrated in FIG. 5.

### MODES FOR CARRYING OUT THE INVENTION

Embodiments of the present invention are described below, but those embodiments are described as examples, and hence it is understood that various modifications may be made thereto without departing from the technical spirit of the present invention. In addition, the same members are represented by the same reference symbols.

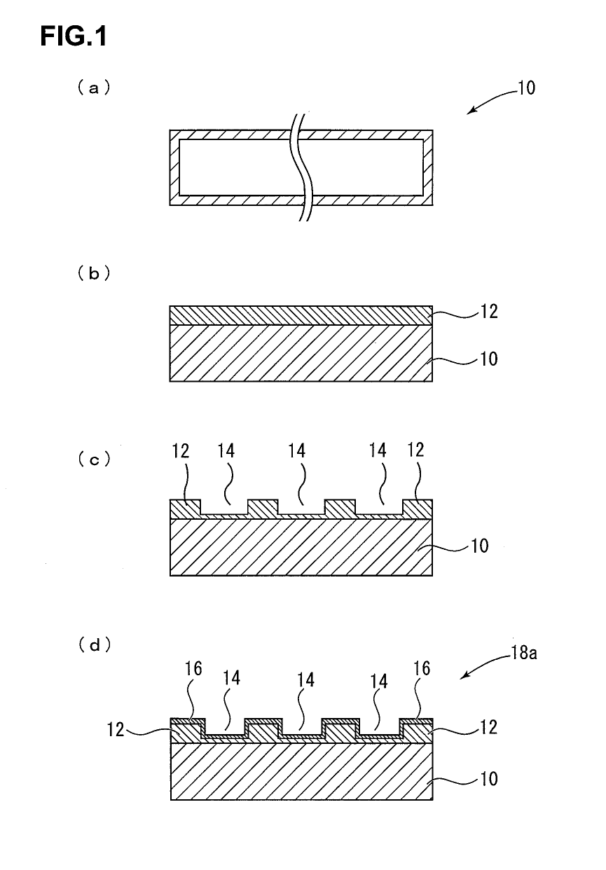

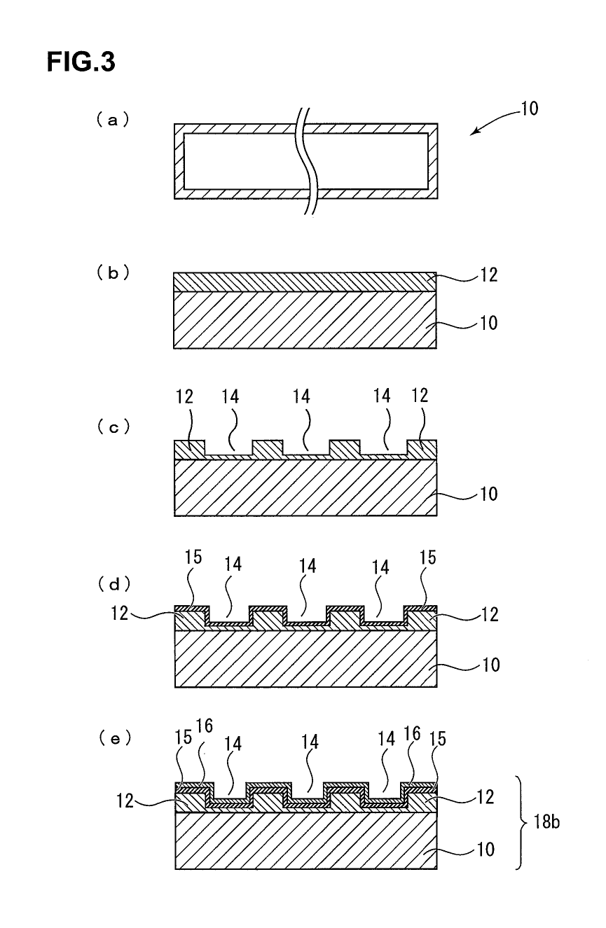

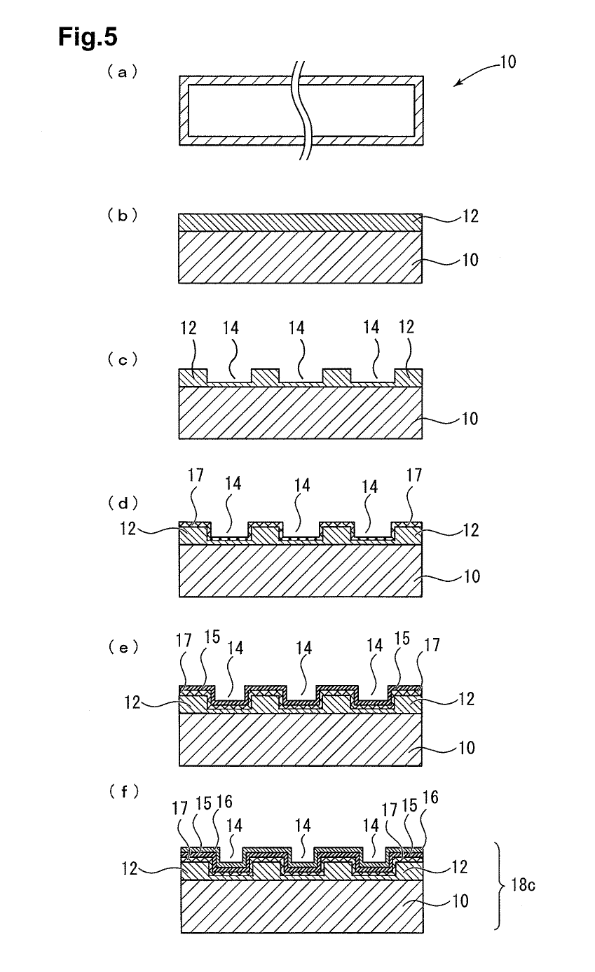

In FIG. 1, FIG. 3, and FIG. 5, reference symbol 10 denotes a cylindrical hollow roll made of aluminum, which is a plate base material.

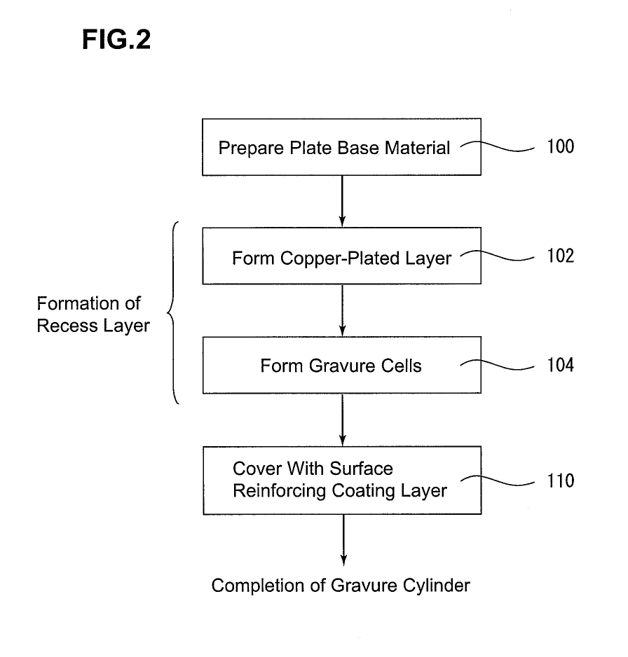

A manufacturing process of one embodiment of a gravure cylinder according to the present invention is described with reference to FIG. 1 and FIG. 2. First, the plate base material 10 is prepared (FIG. 1(a) and Step 100 of FIG. 2). Then, a copper-plated layer 12 is formed on a surface of the plate base material 10 by plating (FIG. 1(b) and Step 102 of FIG. 2).

A recess layer 14 having a large number of minute recesses (gravure cells) formed thereon is formed on a surface of the copper-plated layer 12 (FIG. 1(c) and Step 104 of FIG. 2). As a method of forming the recess layer 14, a known method, for example, an etching method (involving applying a sensitizing solution onto a plate cylinder surface and directly baking the sensitizing solution, followed by etching, to form gravure cells) or an electronic engraving method (involving mechanically operating a diamond engraving needle with a digital signal to engrave gravure cells on a copper surface) may be used, but the etching method is suitable.

Next, a surface reinforcing coating layer 16 made of chromium nitride or carbon nitride is formed on a surface of the recess layer 14 to cover the surface (FIG. 1(d) and Step 110 of FIG. 2). The surface reinforcing coating layer 16 is formed by reactive sputtering.

When the recess layer 14 is covered with the surface reinforcing coating layer 16, a gravure cylinder 18a can be obtained, which has no toxicity and eliminates the concern about the occurrence of pollution and which is excellent in plate life.

Here, sputtering is a method involving causing ionized sputtering gas (inert gas) to strike on a material to be formed into a thin film (target material) to sputter the material and depositing the sputtered material onto a substrate to form a thin film. The sputtering has, for example, the following features: there is little limitation on the target material; and a thin film can be manufactured in a large area with satisfactory reproducibility.

In the present invention, as the sputtering, reactive sputtering is used. Specifically, reactive gas is introduced into a chamber in addition to the sputtering gas, to thereby perform sputtering.

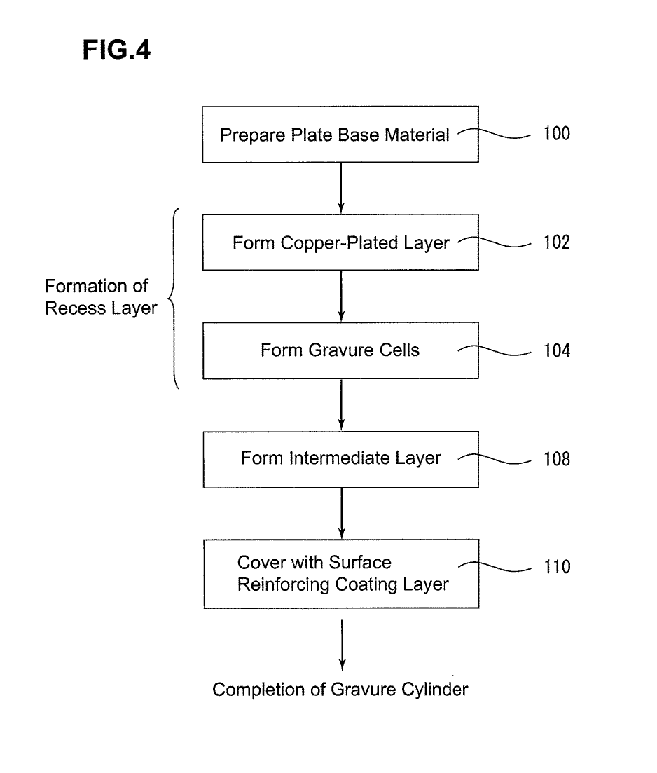

Next, a manufacturing process of another embodiment of a gravure cylinder according to the present invention is described with reference to FIG. 3 and FIG. 4.

First, the plate base material 10 is prepared (FIG. 3(a) and Step 100 of FIG. 4). Then, a metal-plated layer 12 is formed on the surface of the plate base material 10 by metal plating of copper (FIG. 3(b) and Step 102 of FIG. 4).

The recess layer 14 having a large number of minute recesses (gravure cells) formed thereon is formed on a surface of the metal-plated layer 12 (FIG. 3(c) and Step 104 of FIG. 4). As a method of forming the gravure cells, a known method, for example, an etching method (involving applying a sensitizing solution onto a plate cylinder surface and directly baking the sensitizing solution, followed by etching, to form gravure cells) or an electronic engraving method (involving mechanically operating a diamond engraving needle with a digital signal to engrave gravure cells on a copper surface) may be used, but the etching method is suitable.

Next, an intermediate layer 15 is formed on the surface of the recess layer 14 (FIG. 3(d) and Step 108 of FIG. 4).

As the intermediate layer 15, a metal intermediate layer is preferred, and it is suitable that the intermediate layer 15 is made of at least one kind of material selected from the group consisting of Ni, stainless steel, brass, Fe, Cr, Zn, Sn, Ti, Cu, and Al. The intermediate layer is made of at least one kind of material, and hence it goes without saying that the intermediate layer may be made of an alloy. Further, it is preferred that the intermediate layer 15 is a chromium layer formed by sputtering or plating.

Next, the surface reinforcing coating layer 16 made of chromium nitride or carbon nitride is formed (FIG. 3(e) and Step 110 of FIG. 4). The surface reinforcing coating layer 16 is formed by reactive sputtering.

When the intermediate layer 15 is covered with the surface reinforcing coating layer 16, a gravure cylinder 18b can be obtained, which has no toxicity and eliminates the concern about the occurrence of pollution and which is excellent in plate life.

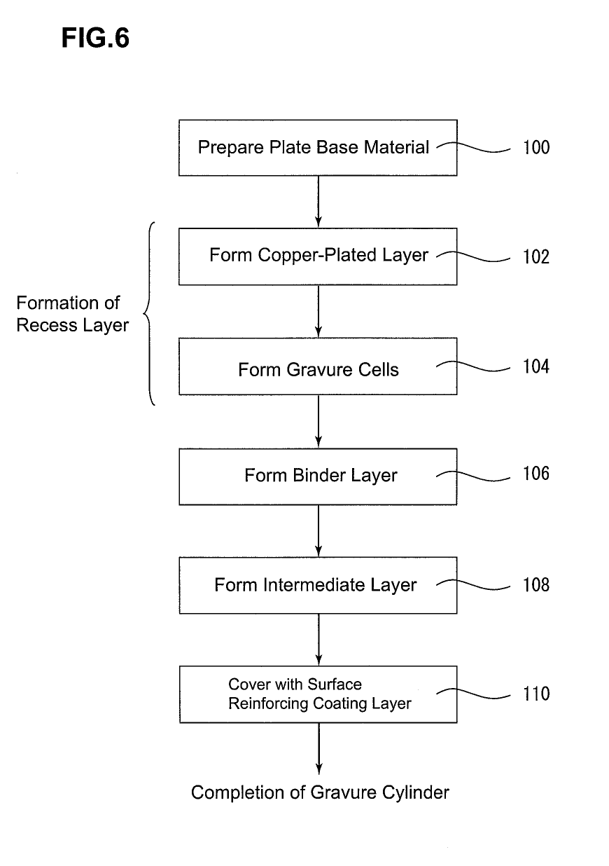

Next, a manufacturing process of still another embodiment of a gravure cylinder according to the present invention is described with reference to FIG. 5 and FIG. 6.

First, the plate base material 10 is prepared (FIG. 5(a) and Step 100 of FIG. 6). Then, the metal-plated layer 12 is formed on the surface of the plate base material 10 by metal plating of copper (FIG. 5(b) and Step 102 of FIG. 6).

The recess layer 14 having a large number of minute recesses (gravure cells) formed thereon is formed on the surface of the metal-plated layer 12 (FIG. 5(c) and Step 104 of FIG. 6). As a method of forming the gravure cells, a known method, for example, an etching method (involving applying a sensitizing solution onto a plate cylinder surface and directly baking the sensitizing solution, followed by etching, to form gravure cells) or an electronic engraving method (involving mechanically operating a diamond engraving needle with a digital signal to engrave gravure cells on a copper surface) may be used, but the etching method is suitable.

Next, a binder layer 17 is formed on the surface of the recess layer 14 (FIG. 5(d) and Step 106 of FIG. 6).

As the binder layer 17, a metal binder layer is preferred, and it is suitable that the binder layer 17 is made of at least one kind of material selected from the group consisting of Ni, stainless steel, brass, Fe, Cr, Zn, Sn, Ti, Cu, and Al. The binder layer is made of at least one kind of material, and hence it goes without saying that the binder layer may be made of an alloy. Further, it is preferred that the binder layer 17 is a nickel layer formed by sputtering or plating.

Next, the intermediate layer 15 is formed on a surface of the binder layer 17 (FIG. 5(e) and Step 108 of FIG. 6).

As the intermediate layer 15, a metal intermediate layer is preferred, and it is suitable that the intermediate layer 15 is made of at least one kind of material selected from the group consisting of Ni, stainless steel, brass, Fe, Cr, Zn, Sn, Ti, Cu, and Al. The intermediate layer is made of at least one kind of material, and hence it goes without saying that the intermediate layer may be made of an alloy. Further, it is preferred that the intermediate layer 15 is a chromium layer formed by sputtering or plating.

Next, the surface reinforcing coating layer 16 made of chromium nitride or carbon nitride is formed on a surface of the intermediate layer 15 (FIG. 5(f) and Step 110 of FIG. 6). The surface reinforcing coating layer 16 is formed by reactive sputtering.

When the intermediate layer 15 is covered with the surface reinforcing coating layer 16, a gravure cylinder 18c can be obtained, which has no toxicity and eliminates the concern about the occurrence of pollution and which is excellent in plate life.

### EXAMPLES

Now, the present invention is more specifically described by way of Examples, but it is needless to say that Examples are only illustrative and should not be interpreted as limiting the present invention.

### Example 1

A plate base material (aluminum hollow roll) having a circumference of 600 mm and a surface length of 1,100 mm was prepared, and a gravure cylinder (gravure plate-making roll) to be described later was manufactured through use of NewFX (fully automatic laser gravure plate-making system manufactured by Think Laboratory Co., Ltd.). First, the plate base material (aluminum hollow roll) serving as a roll to be processed was mounted onto a copper plating bath and completely immersed in a plating solution, to thereby form a copper-plated layer of 40 μm at 30 A/dm² and 6.0 V. No nodules and pits were generated on the plated surface, and a uniform copper-plated layer serving as a base material was obtained. The surface of the copper-plated layer was polished through use of a two-head polishing machine (polishing machine manufactured by Think Laboratory Co., Ltd.), to thereby form a uniform polished surface as the surface of the copper-plated layer.

Next, a photosensitive material (thermal resist: TSER2104 E4 (manufactured by Think Laboratory Co., Ltd.)) was applied (with a fountain coater) onto the surface of the roll to be processed having formed thereon the copper-plated layer and dried. The thickness of the obtained photosensitive material was measured with a thickness meter (F20 manufactured by Filmetrics, Inc. and sold by Matsushita Techno Trading Co., Ltd.) to be 4.5 μm. Then, an image was developed by laser exposure. The laser exposure was performed with a predetermined pattern under an exposure condition of 300 mJ/cm² through use of Laser Stream FX. Further, the development was performed through use of a TLD developing solution (developing solution manufactured by Think Laboratory Co., Ltd.) with a developing solution dilution ratio (undiluted solution:water=1:7) at 24° C. for 90 seconds, to thereby form a predetermined resist pattern. Then, the copper-plated layer was corroded through use of the resist pattern thus formed as an etching mask. The corrosion was performed by spraying a copper(II) chloride solution serving as a corrosive liquid onto the copper-plated layer at 35° C. for 100 seconds. Then, the resist of the resist pattern was peeled through use of sodium hydroxide with a dilution ratio of 20 g/L at 40° C. for 180 seconds. Thus, a large number of square recesses (gravure cells) each having a depth of 20 μm and a side length of 145 μm were formed.

In order to form a binder layer, the roll to be processed having a large number of recesses formed on a surface was mounted onto a nickel plating bath and completely immersed in a plating solution, to thereby form a nickel-plated layer of 2 μm at 3 A/dm² and 6.0 V. No nodules and pits were generated on the plated surface, and a uniform nickel-plated layer serving as a binder layer was obtained.

Then, a chamber in a sputtering device was evacuated to 1.0×10⁻³ Pa or less, and the roll to be processed, having the nickel-plated layer formed thereon, was subjected to Ar bombardment in order to remove a surface oxide film of a film formation object (surface temperature: 100° C.).

Next, in order to increase the adhesiveness with respect to the plate base material, a Cr layer serving as an intermediate layer was formed by sputtering. The conditions of forming the intermediate layer are shown in Table 1. The thickness of the Cr layer was 0.05 μm.

TABLE 1
Discharge procedure: Sputtering
Process gas/flow rate: Ar/70 sccm
Process pressure: 0.283 Pa No pressure adjustment
Process time: 2 minutes
Bias voltage: DC 60 V

Next, a chromium nitride layer was formed as a surface reinforcing coating layer on the intermediate layer by reactive sputtering. The conditions of forming the surface reinforcing coating layer are shown in Table 2.

TABLE 2
Common items
Discharge procedure: Reactive sputtering
Bias voltage: DC 60 V
[Gradient film 1]
Process gas/flow rate: Ar/70 sccm N₂/5 sccm
Process pressure: 0.285 Pa No pressure adjustment
Process gas partial pressure ratio: Ar:N₂ = 12:1
Process time: 10 minutes
[Gradient film 2]
Process gas/flow rate: Ar/68 sccm N₂/6 sccm
Process pressure: 0.284 Pa No pressure adjustment
Process gas partial pressure ratio: Ar:N₂ = 8.7:1
Process time: 20 minutes
[Gradient film 3]
Process gas/flow rate: Ar/64 sccm N₂/8 sccm
Process pressure: 0.273 Pa No pressure adjustment
Process gas partial pressure ratio: Ar:N₂ = 6.2:1
Process time: 30 minutes
[Gradient film 4]
Process gas/flow rate: Ar/62 sccm N₂/11 sccm
Process pressure: 0.261 Pa No pressure adjustment
Process gas partial pressure ratio: Ar:N₂ = 5:1
Process time: 110 minutes

As shown in Table 2, gradient films 1 to 4 were formed successively in the stated order while the flow rate, partial pressure ratio, and process pressure of Ar gas and N₂ gas serving as the process gas were changed. Thus, a stiff chromium nitride layer was formed by gradually increasing the amount of N₂ gas. The thickness of the surface reinforcing coating layer was 4 μm.

After the completion of the reactive sputtering, the roll to be processed was cooled and removed from the chamber. Thus, a gravure cylinder was manufactured. The surface of the gravure cylinder was observed with an optical microscope to confirm high-definition gravure cells in which a large number of recesses were formed on a surface.

### Example 2

In the same manner as in Example 1, a large number of recesses (gravure cells) were formed on a surface of a plate base material, and then a nickel-plated layer was formed as a binder layer, and a Cr layer was formed as an intermediate layer by sputtering. After that, the process gas was changed to N₂ gas and methane gas, and a carbon nitride layer was formed as a surface reinforcing coating layer on the intermediate layer by reactive sputtering. The conditions of forming the surface reinforcing coating layer are shown in Table 3.

TABLE 3
Common items
Discharge procedure: Reactive sputtering
Bias voltage: DC 60 V
[Gradient film 1]
Process gas/flow rate: Ar/71 sccm CH₄/6 sccm
Process pressure: 0.300 Pa No pressure adjustment
Process gas partial pressure ratio: Ar:N₂ = 14:1
Process time: 10 minutes
[Gradient film 2]
Process gas/flow rate: Ar/68 sccm CH₄/8 sccm
Process pressure: 0.300 Pa No pressure adjustment
Process gas partial pressure ratio: Ar:N₂ = 9:1
Process time: 20 minutes
[Gradient film 3]
Process gas/flow rate: Ar/62 sccm N₂/15 sccm
Process pressure: 0.300 Pa No pressure adjustment
Process gas partial pressure ratio: Ar:N₂ = 6.5:1
Process time: 30 minutes
[Gradient film 4]
Process gas/flow rate: Ar/62 sccm N₂/15 sccm
Process pressure: 0.300 Pa No pressure adjustment
Process gas partial pressure ratio: Ar:N₂ = 5:1
Process time: 110 minutes

After the completion of the reactive sputtering, the roll to be processed was cooled and removed from the chamber. Thus, a gravure cylinder was manufactured. The surface of the gravure cylinder was observed with an optical microscope to confirm high-definition gravure cells in which a large number of recesses were formed on a surface. The thickness of the surface reinforcing coating layer was 4 μm.

### Comparative Example 1

A plate base material (aluminum hollow roll) having a circumference of 600 mm and a surface length of 1,100 mm was prepared, and a gravure cylinder (gravure plate-making roll) to be described later was manufactured through use of NewFX (fully automatic laser gravure plate-making system manufactured by Think Laboratory Co., Ltd.). First, the plate base material (aluminum hollow roll) serving as a roll to be processed was mounted onto a copper plating bath and completely immersed in a plating solution, to thereby form a copper-plated layer of 40 μm at 30 A/dm² and 6.0 V. No nodules and pits were generated on the plated surface, and a uniform copper-plated layer serving as a base material was obtained. The surface of the copper-plated layer was polished through use of a two-head polishing machine (polishing machine manufactured by Think Laboratory Co., Ltd.), to thereby form a uniform polished surface as the surface of the copper-plated layer.

Next, a photosensitive material (thermal resist: TSER2104 E4 (manufactured by Think Laboratory Co., Ltd.)) was applied (with a fountain coater) onto the surface of the roll to be processed having formed thereon the copper-plated layer and dried. The thickness of the obtained photosensitive material was measured with a thickness meter (F20 manufactured by Filmetrics, Inc. and sold by Matsushita Techno Trading Co., Ltd.) to be 4.5 μm. Then, an image was developed by laser exposure. The laser exposure was performed with a predetermined pattern under an exposure condition of 300 mJ/cm² through use of Laser Stream FX. Further, the development was performed through use of a TLD developing solution (developing solution manufactured by Think Laboratory Co., Ltd.) with a developing solution dilution ratio (undiluted solution:water=1:7) at 24° C. for 90 seconds, to thereby form a predetermined resist pattern. Then, the copper-plated layer was corroded through use of the resist pattern thus formed as an etching mask. The corrosion was performed by spraying a copper(II) chloride solution serving as a corrosive liquid onto the copper-plated layer at 35° C. for 100 seconds. Then, the resist of the resist pattern was peeled through use of sodium hydroxide with a dilution ratio of 20 g/L at 40° C. for 180 seconds. Thus, a large number of square recesses (gravure cells) each having a depth of 20 μm and a side length of 145 μm were formed.

The roll to be processed having a large number of recesses formed on a surface was mounted onto a chromium plating bath and completely immersed in a plating solution, to thereby form a hexavalent chromium-plated layer of 4 μm at 30 A/dm² and 6.0 V. No nodules and pits were generated on the plated surface, and a uniform chromium-plated layer was obtained. Thus, a gravure cylinder was manufactured. The surface of the gravure cylinder was observed with an optical microscope to confirm high-definition gravure cells in which a large number of recesses were formed on a surface. The thickness of the chromium-plated layer was 4 μm.

<Evaluation Test Method>

As evaluation of wear resistance of the surface of each of the gravure cylinders manufactured in Examples and Comparative Example, a wear test based on a ball-on-disc method was performed through use of a test piece.

A surface reinforcing coating layer was formed to have a thickness of 4 μm on each test piece (copper plating of 80 μm) by the same procedure as those of Examples 1 and 2 and Comparative Example.

As a testing device, “Tribometer” manufactured by Anton Paar GmbH (Switzerland) was used. Each of the test pieces was set in the measurement device, and an alumina ball having a diameter of 6 mm was set as a mating member on a holder. A test was performed under the conditions of a load of 1 N, a rotation speed of 10 cm/sec, a rotation radius of 3 mm, a number of rotations of 20,000 rap, and an unlubricated state.

A wear amount was digitized with a product of a wear width and a wear depth.

As a measurement device, “white interferometer (VertScan)” manufactured by Ryoka Systems Inc. was used, and a wear width and a wear depth were measured based on a wear cross-section. The evaluation results are shown in Table 4.

TABLE 4

| | Surface reinforcing | Wear width | Wear depth | Wear |
|---|---|---|---|---|
| | coating layer (film) | (μm) | (μm) | amount |
| Example 1 | Chromium nitride | 78.34 | 0.15 | 11.8 |
| Example 2 | Carbon nitride | 76.55 | 0.10 | 7.7 |
| Comparative | Chromium plating | 102.45 | 0.57 | 58.4 |
| Example 1 | | | | |

### REFERENCE SIGNS LIST

10: plate base material, 12: metal-plated layer, 14: gravure cell, 15: intermediate layer, 16: surface reinforcing coating layer, 17: binder layer, 18a, 18b, 18c: gravure cylinder.

1. A gravure cylinder, comprising:
a plate base material;
a recess layer formed on a surface of the plate base material and the recess layer including a number of recesses formed on the surface; and
a surface reinforcing coating layer configured to cover the recess layer with chromium nitride or carbon nitride, wherein the surface reinforcing coating layer is formed by reactive sputtering.

2. A gravure cylinder according to claim 1, further comprising an intermediate layer formed between the recess layer and the surface reinforcing coating layer.

3. A gravure cylinder according to claim 2, wherein the intermediate layer comprises a metal intermediate layer.

4. A gravure cylinder according to claim 3, wherein the metal intermediate layer comprises a chromium layer formed by sputtering or plating.

5. A gravure cylinder according to claim 2, further comprising a binder layer formed between the recess layer and the intermediate layer.

6. A gravure cylinder according to claim 5, wherein the binder layer comprises a metal binder layer.

7. A gravure cylinder according to claim 6, wherein the metal binder layer comprises a nickel layer formed by sputtering or plating.

8. A method of manufacturing a gravure cylinder, the method comprising steps of:
preparing a plate base material;
forming a recess layer including a number of recesses on a surface of the plate base material; and
forming a surface reinforcing coating layer configured to cover the recess layer with chromium nitride or carbon nitride by reactive sputtering.

9. A method of manufacturing a gravure cylinder according to claim 8, further comprising forming an intermediate layer between the recess layer and the surface reinforcing coating layer.

10. A method of manufacturing a gravure cylinder according to claim 9, wherein the intermediate layer comprises a metal intermediate layer.

11. A method of manufacturing a gravure cylinder according to claim 10, wherein the metal intermediate layer comprises a chromium layer formed by sputtering or plating.

12. A method of manufacturing a gravure cylinder according to claim 9, further comprising forming a binder layer between the recess layer and the intermediate layer.

13. A method of manufacturing a gravure cylinder according to claim 12, wherein the binder layer comprises a metal binder layer.

14. A method of manufacturing a gravure cylinder according to claim 13, wherein the metal binder layer comprises a nickel layer formed by sputtering or plating.

15. A method of manufacturing a printed matter, the method comprising:
performing printing on a material to be printed via a gravure cylinder, the gravure cylinder comprising a plate base material, a recess layer and a surface reinforcing coating layer configured to cover the recess layer with chromium nitride or carbon nitride, the recess layer being formed on a surface of the plate base material and the recess layer including a number of recesses formed on the surface, wherein the surface reinforcing coating layer is formed by reactive sputtering.

16. A printed matter, which is printed by the method of manufacturing the printed matter of claim 15.
